(19) United States
(12) Patent Application Publication
(10) Pub. No.: US 2008/0289772 A1
(43) Pub. Date: Nov. 27, 2008

(54) Method and Apparatus For Mounting a Tire

(76) Inventor: William Manning Reeves Jr., Townville, SC (US)

Correspondence Address: DORITY & MANNING, PA & MICHELIN NORTH AMERICA, INC, P O BOX 1449, GREENVILLE, SC, 29602-1449, US

(21) Appl. No.: 11/916,577

(22) PCT Filed: Jun. 6, 2005
(86) PCT No.: PCT/US2005/019766

§ 371 Date: Jun. 24, 2008

(51) Int. Cl. B60C 25/00

(52) U.S. Cl. 157/1.1

(57) ABSTRACT

Methods and apparatus for mounting a tire onto a wheel rim are provided. The wheel rim has an inside bead seat and an outside bead seat for receipt of an inside bead and an outside bead of the tire respectively. The wheel rim may also have a seat for receipt of a support ring. Seating of the bead rings of the tire into the bead seats is provided. When a support ring is desired and the wheel rim has a seat for receipt of the support ring, seating of the support ring as well as the tire onto the wheel rim is also provided. In certain embodiments, substantially simultaneous mounting of the inside and outside beads of the tire is provided by rollers that press these beads towards one another and onto the respective bead seats of the wheel rim.

### FIELD OF THE INVENTION

The present invention relates to method and apparatus for mounting a tire onto a wheel rim. The wheel rim has an inside bead seat and an outside bead seat for receipt of an inside bead and an outside bead of the tire respectively. The wheel rim may also have a seat for receipt of the support ring. The present invention allows for seating of the bead rings of the tire into the bead seats. When a support ring is desired and a wheel rim having a seat for receipt of the support ring is provided, the present invention also provides for seating of the support ring as well as the tire onto the wheel rim. In certain embodiments, substantially simultaneous mounting of the inside and outside beads of the tire is provided by rollers that press these beads towards one another and onto the respective bead seats of the wheel rim.

### BACKGROUND OF THE INVENTION

The use of a support ring within a tire to provide for extended mobility during periods of low or zero inflation pressure has been previously described. For example, U.S. Pat. No. 5,891,279, which is incorporated herein by reference, describes such a support for tires that is constructed from a flexible material. As described therein, the support ring is mounted on the wheel rim within the tire.

For the purposes of discussion, FIG. 6 illustrates a rim 10 onto which a tire 12 and support ring 14 are mounted. Rim 10 includes inside rim well 13, support ring seat 15, inside bead seat 17 and outside bead seat 19. When mounted into the proper position, support ring 14 rests within support ring seat 15. Similarly, when tire 12 is properly seated, inside or bottom bead 16 rests upon inside bead seat 17 while outside or top bead 18 rests upon outside bead seat 19. As shown, the circumference of inside bead seat 17 is larger than the circumference of outside bead seat 19, and the circumference of inside bead 16 is larger than outside bead 18. Accordingly, inside bead 16 of tire 12 can be readily placed onto rim 10 by first inserting that side of rim 10 forming outside bead seat 19 into tire 12. However, the subsequent placement of beads 16 and 18 as well as support ring 14 into their proper respective positions requires a certain degree of lateral or axially directed force. The present invention provides for a method and apparatus of properly seating ring 14 and tire 12 onto rim 10. As may be desirable for some applications, the present inventions also provides for a method and apparatus of properly seating only tire 12 onto rim 10 and without mounting a support ring 14.

### SUMMARY OF THE INVENTION

Various features and advantages of the invention will be set forth in part in the following description, or may be obvious from the description. The present invention provides method and apparatus for mounting a tire onto a wheel rim. As desired, method and apparatus of the present invention may also be used to mount a tire and a support ring onto the wheel rim. Exemplary steps and embodiments of the present invention will now be summarized with a detailed, enabling description and claims to follow.

In one exemplary method of the present invention, a procedure for mounting a tire onto a wheel rim is provided. The tire has an inside bead and an outside bead, and the wheel rim defines axial and radial directions. The method includes the following steps, it being understood that using the teaching disclosed herein the order of the steps may be modified depending upon the application. The tire is placed over the rim such that the inside bead is located at an intermediate position around the rim and the outside bead is located axially outside of the rim. As the rim is then caused to rotate, the inside bead is moved to a position axially outside of the rim. The inside bead and the outside bead of the tire are the pressed axially towards each other while moving the rim radially so as to urge the inside and outside bead into respective mounted positions on the rim.

Steps may also be added to this exemplary method in order to mount a support ring onto the wheel rim. Accordingly, a support ring is inserted into the tire prior to placing the tire onto the wheel rim. As the tire is placed onto the rim, the support ring is positioned onto the rim during so that the support ring is located at least partially around the rim. An axially directed force is applied to the support ring while rotating the rim so as to urge the support ring into its mounted position on the wheel rim. Where desirable, an additional step may be provided of moving the outside bead generally in a radial direction so as to at least partially expose the support ring prior to the step of applying an axially directed force to the support ring.

Various modifications to the above exemplary procedures may be provided. By way of example only, the pressing step may include applying axially-directed forces initially at a position located substantially at the center of the wheel rim. Additionally, the pressing step may include simultaneously applying axially directed forces to the inside bead and the outside bead. During the pressing steps, the rim may be moved first in one radial direction and then in an opposite radial direction. Additional, the rim may be rotated during the pressing step.

In an exemplary embodiment of the present invention, an apparatus for mounting a tire onto a wheel rim is provided in which the tire has an inside bead and an outside bead and the rim has an inside bead seat and an outside bead seat. The apparatus includes a slide that is selectively movable between a first and second position. A pedestal is attached to the slide. The pedestal includes a hub for the receipt of the rim. The hub defines axial and radial directions and is capable of being rotated about the axial direction. An actuator is attached to the slide. The actuator includes an inside bead receiving element configured for receipt of the inside bead and is configured with a cam that defines the radial position of the inside bead receiving element when the actuator is caused to move in the axial direction. Preferably, the cam is configured so as to cause the inside bead receiving element to pull the inside bead down and outside of the rim as the actuator is moved vertically downward.

A rim press is attached to the slide and includes a shaft configured for rotation about the axial direction. The shaft is movable in the axial direction so as to selectively secure the rim between the shaft and the hub. Preferably, the shaft includes a wheel cone positioned at an end of the shaft and configured for complementary receipt by the wheel rim. A plurality of upper and lower bead rollers are located proximate to the second position. The bead rollers are movable along the axial direction towards or away from the tire when in position on the hub. The bead rollers are configured for pressing the inside and outside bead rings into the inside and the bead seats respectively.

Where mounting of a support ring is desired, additional features can be provided for this exemplary embodiment. For example, a support ring roller can be located proximate to the first position. Such support ring roller includes an outside bead receiving element configured for receipt of the outside bead of the tire, and the support ring roller is movable along the axial direction towards or away from the slide.

Additional features may be provided. By way of example only, a first power source can be connected to the slide by a screw drive for selectively moving the between the first and the second positions. A second power source can be connected to the hub for selectively causing the hub to rotate about the axial direction. A third power source can be connected to the actuator for selectively causing the actuator to move in the axial direction. A linear transducer cylinder can be provided that is in mechanical communication with the support ring roller and is configured to provide for selective movement of the support ring roller along the axial direction.

The plurality of upper and lower bead rollers can be constructed to define an opening through which the pedestal may be carried by the slide towards the second position. A plurality of wheel support rollers can be located proximate to the first position and configured for supporting the tire as it is rotated by the hub.

For removing the mounted tire, at least one exit conveyor can be provided. The exit conveyor is movable along the axial direction and is located proximate to the second position. The exit conveyor is configured for lifting the tire from the hub and transporting the tire away from the pedestal. Alternatively, at least one pair of exit conveyors can be provided that include a plurality of guides supporting the exit conveyors. As such, the exit conveyors are configured for sliding along the guides, which extend at an angle so that the exit conveyors overlap upon being moved towards one another along the guides. At least two cylinders attached to the pair of exit conveyors and are configured for selectively moving the exit conveyors along the guides.

In certain applications, a frame may be provided, to which at least the slide, the rim press, and the plurality of upper and lower bead rollers are attached.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of an exemplary embodiment of the invention.

FIG. 2 illustrates the lines along which FIG. 1 is sectioned in order to provide for the perspective views of FIGS. 2A through 2D.

FIG. 3A provides another perspective view of the exemplary embodiment of the invention shown in FIG. 1.

FIGS. 3B through 3O provide a perspective view of a portion of the exemplary embodiment of the present invention illustrated in FIG. 3A.

FIGS. 4 and 5 each provide perspective views of a portion of the exemplary embodiment of the present invention illustrated in FIG. 3A.

FIG. 6 is a cross-section of an exemplary support ring, tire, and rim that can be mounted using the present invention.

FIG. 7 is a perspective view of a portion of the exemplary embodiment of the present invention illustrated in FIG. 3A.

### DETAILED DESCRIPTION OF THE PREFERRED EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

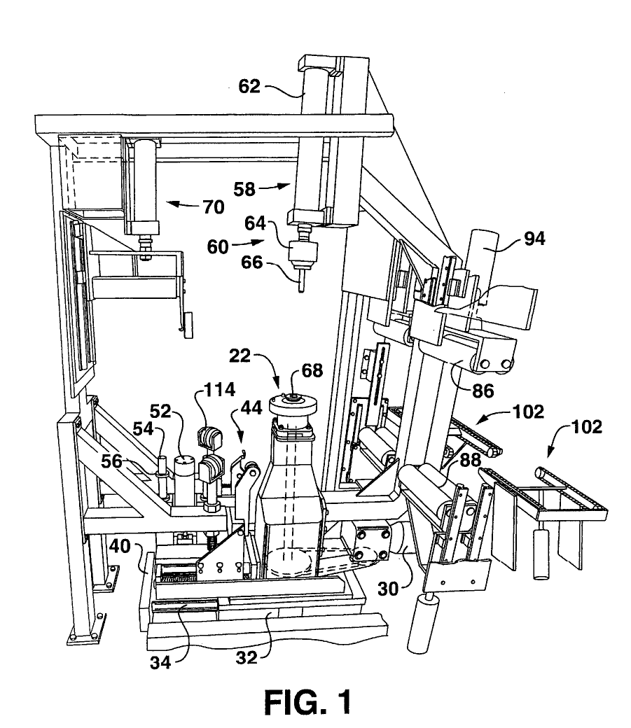

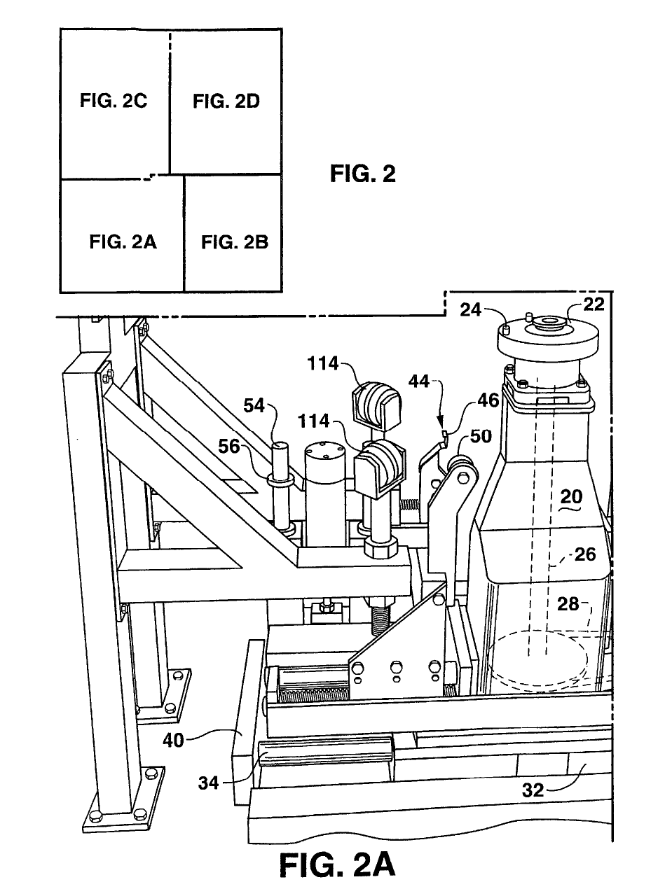

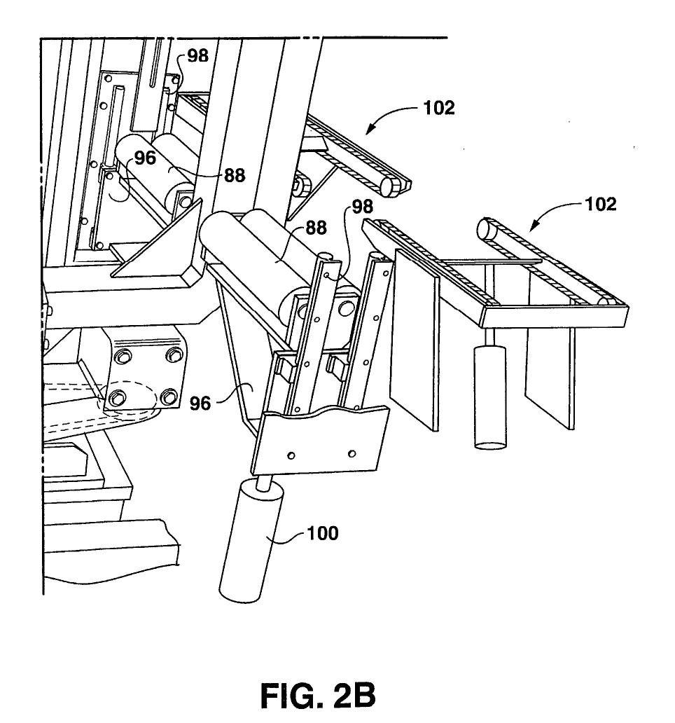

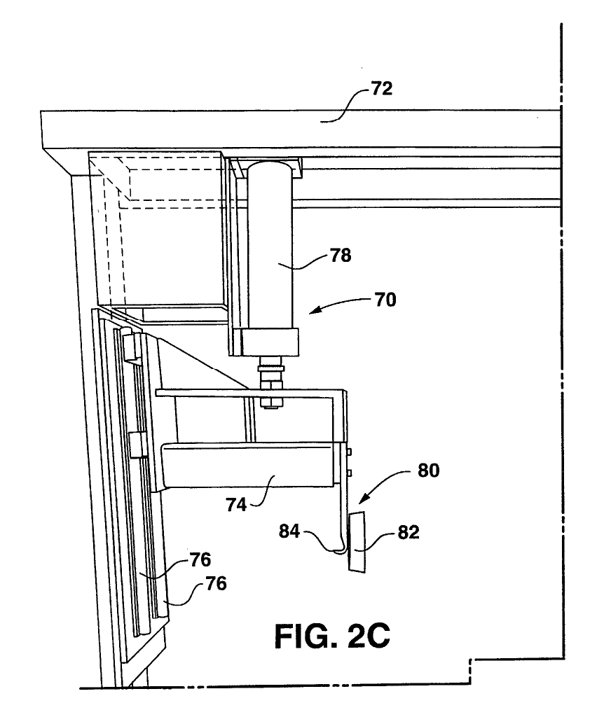

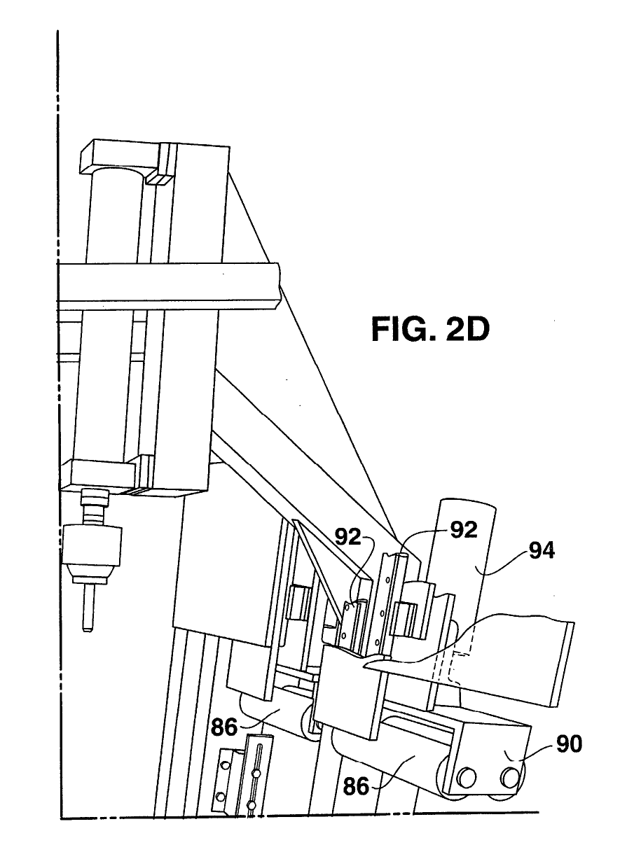

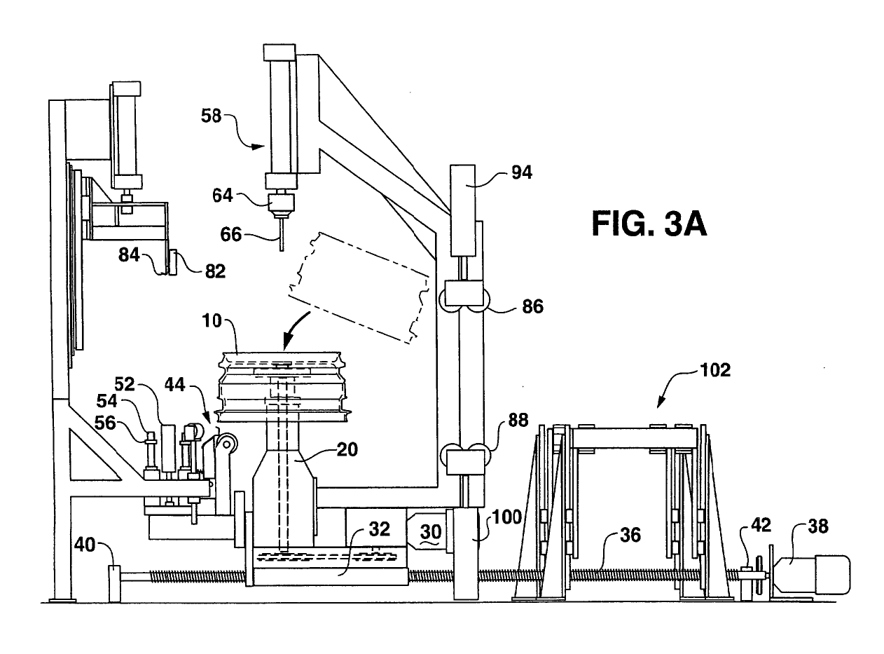

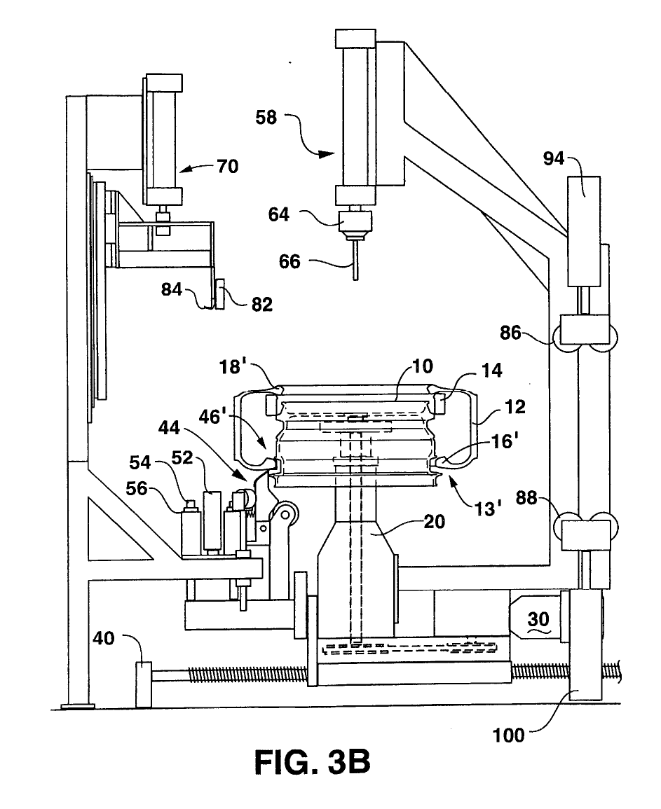

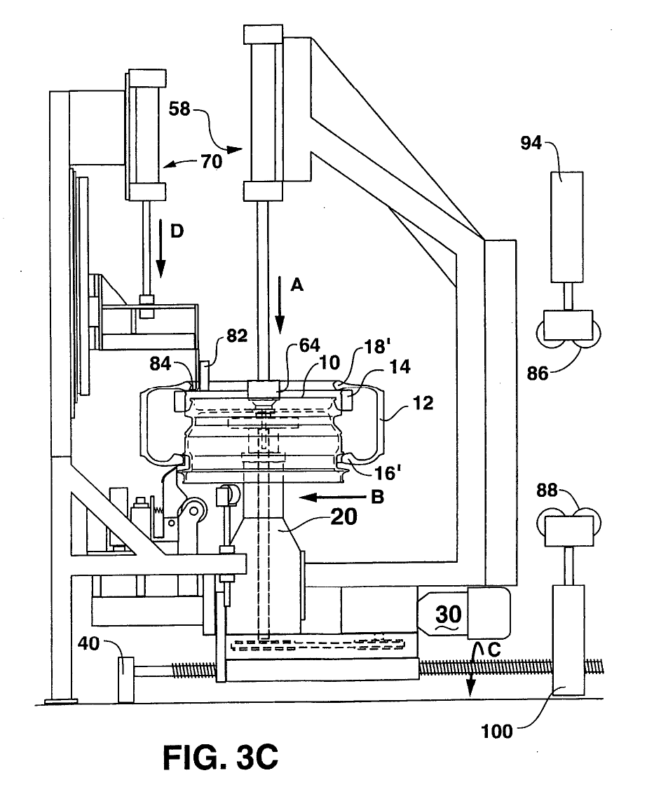

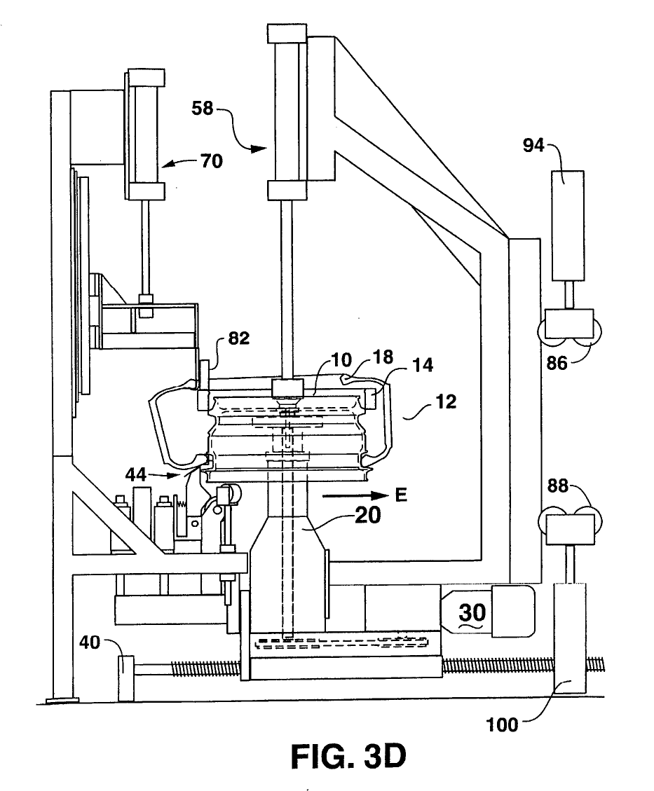

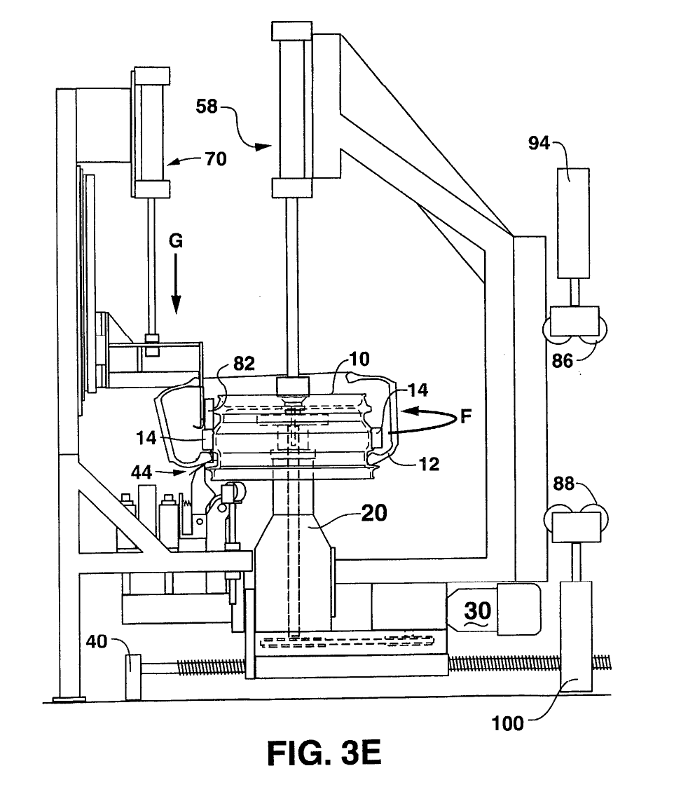

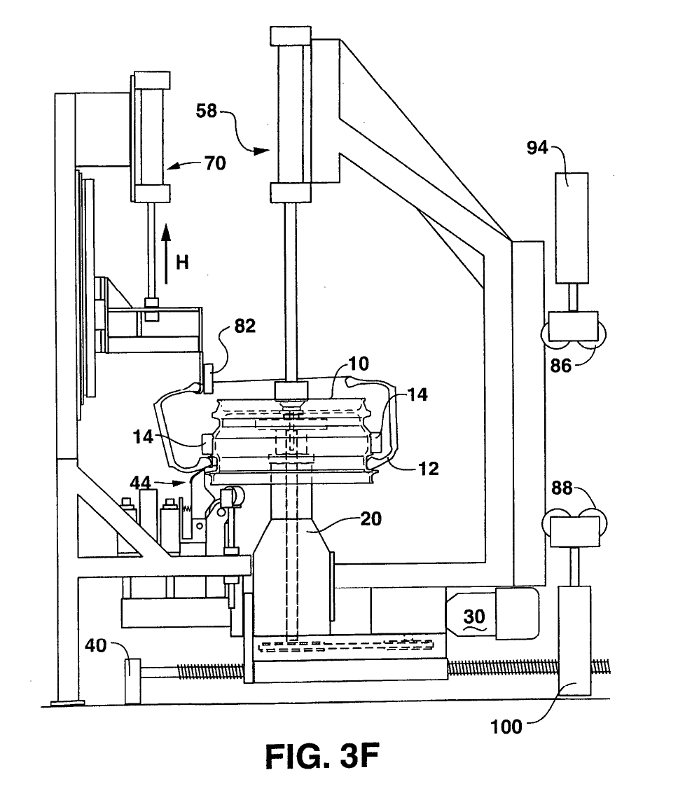

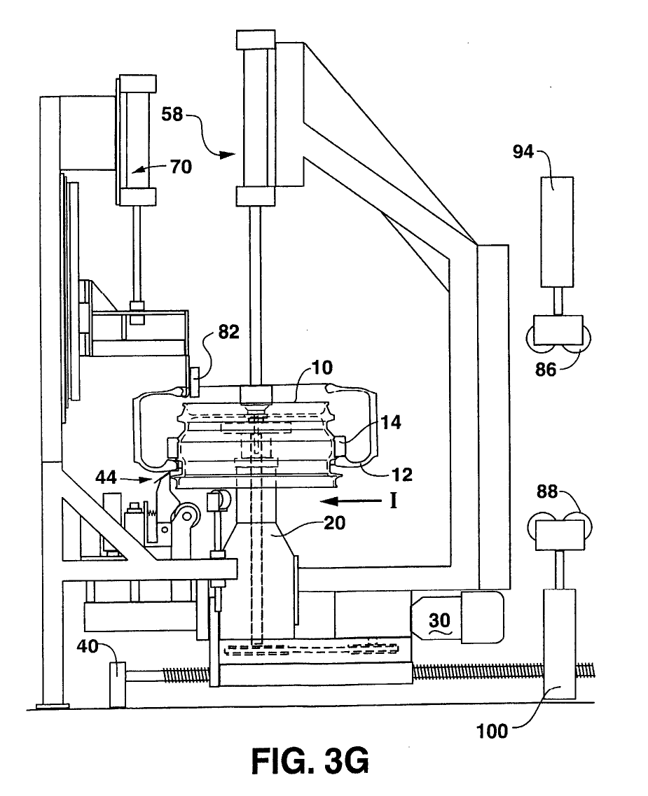

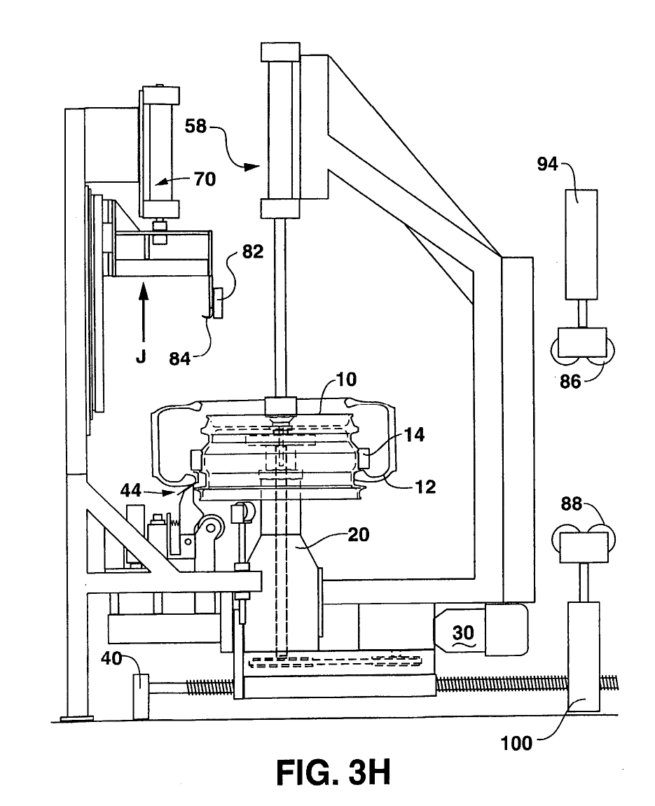

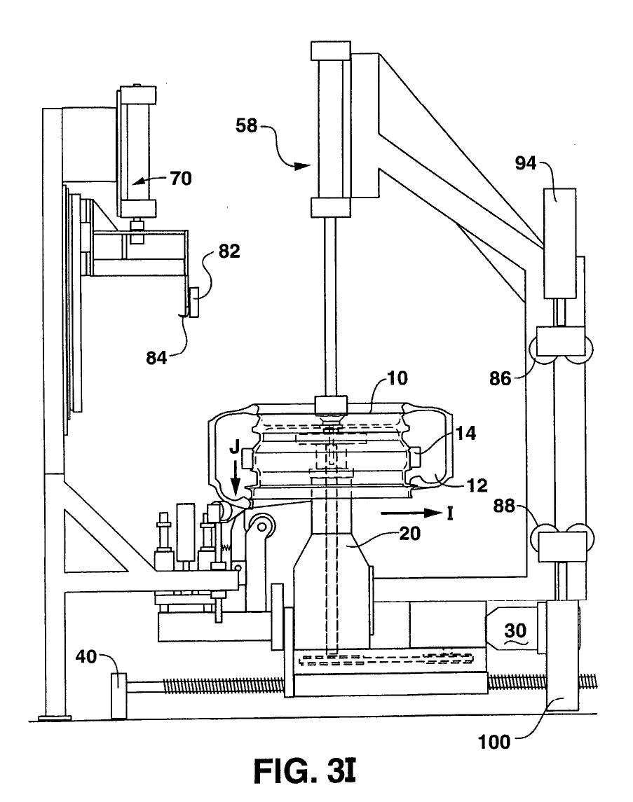

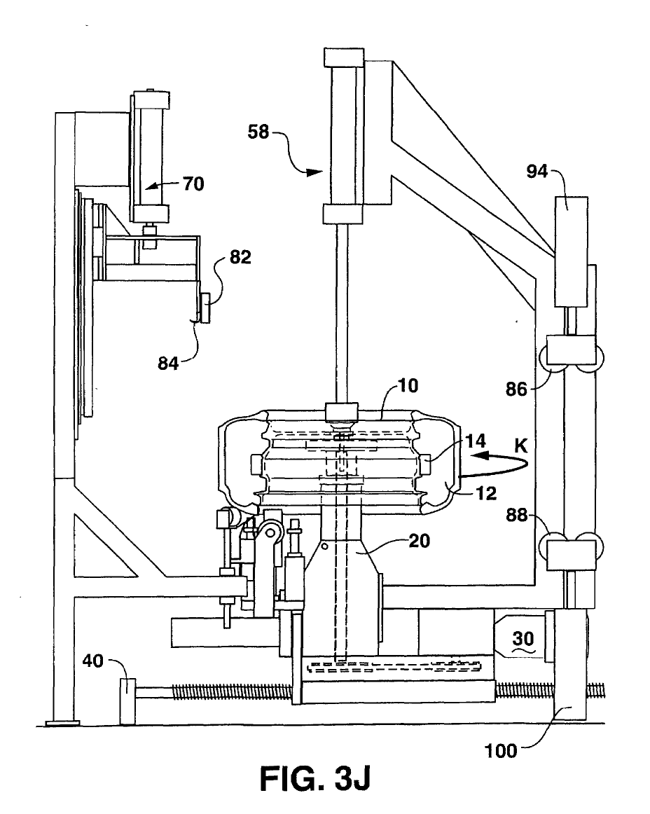

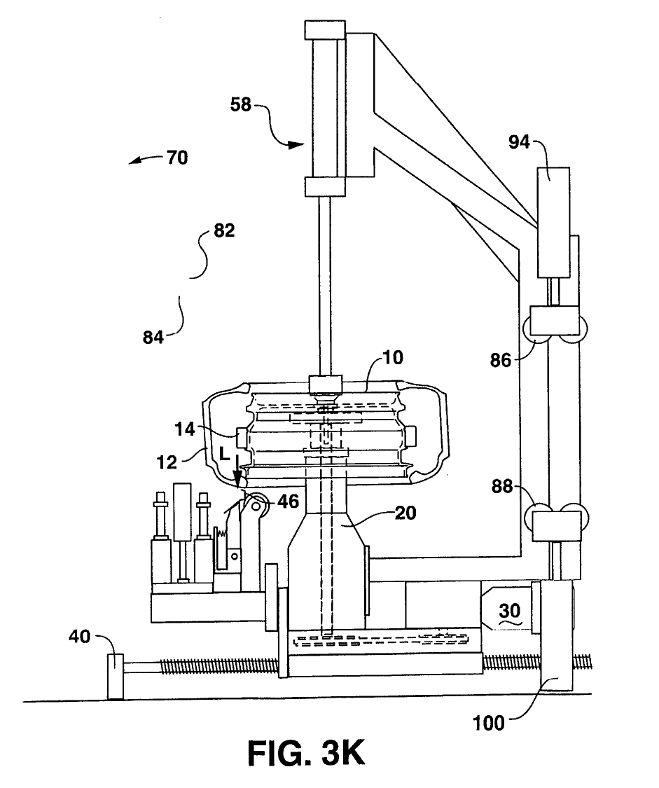

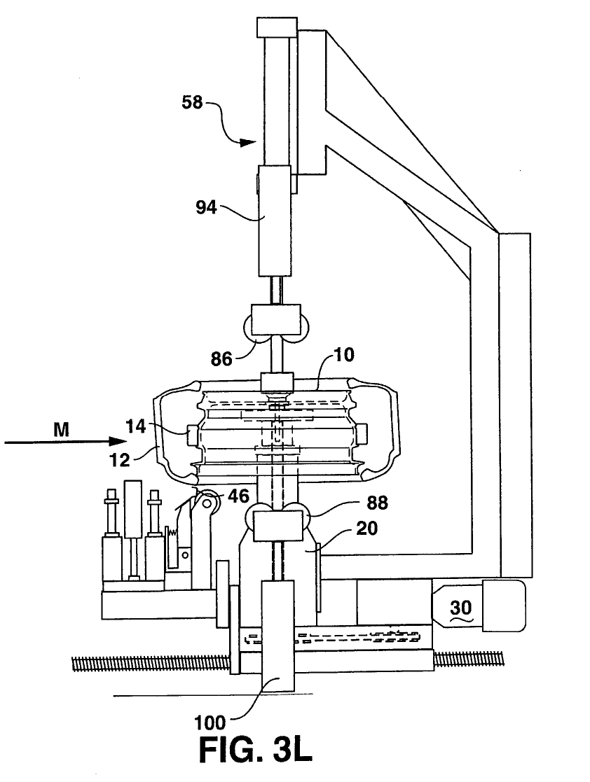

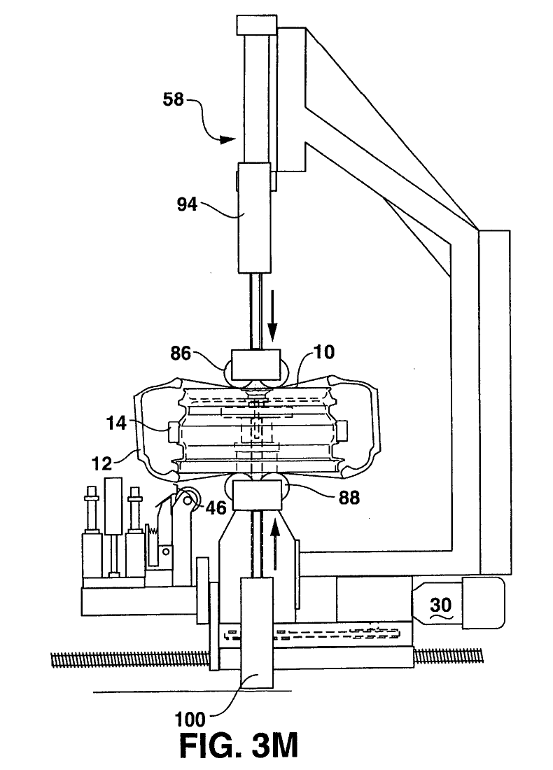

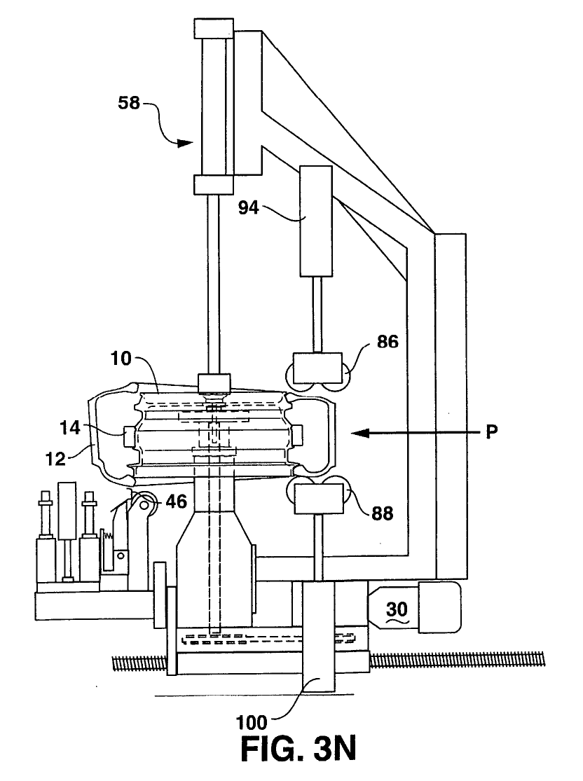

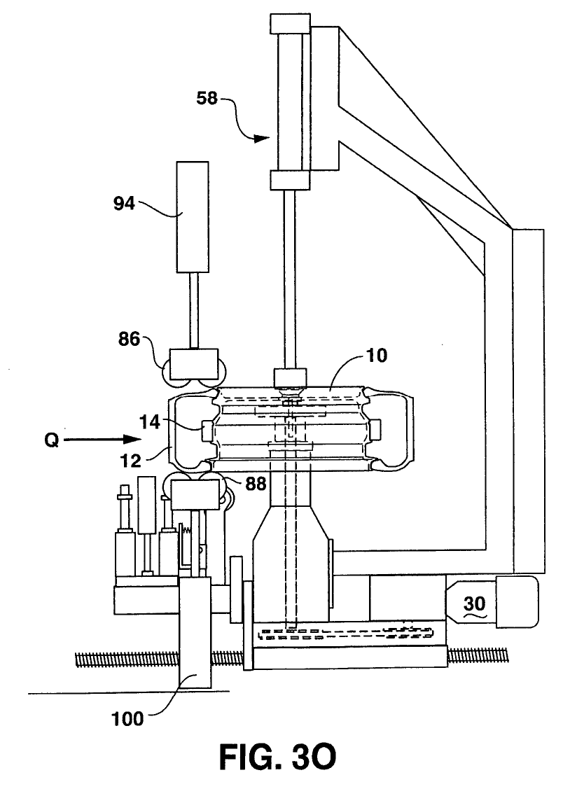

FIG. 1 provides a perspective view of an exemplary embodiment of the present invention. FIGS. 3A through 3O provide an overall side view of this exemplary embodiment of the present invention and also include various depictions of a rim 10, tire 12, support ring 14 being mounted as will be later described. For purposes of clarity, a cage, various operator presence sensors, controls, and control panels that might be employed are not shown in any of the figures but the use and presence of such will be understood by one of ordinary skill in the art using the teaching disclosed herein. FIGS. 2A through 2D illustrate perspective views of the exemplary embodiment shown in FIG. 1, but magnified and separated in four sections along the lines shown in FIG. 2 for the purposes of discussion.

Focusing primarily now on FIG. 1 and FIG. 2A though 2D, a pedestal 20 is provided for receipt and support of the rim 10, tire 12, and support ring 14 (which are shown in FIG. 3B for example) during the mounting procedure. Pedestal 20 supports a hub 22 onto which the wheel rim 10 will be placed. Hub 22 is provided with pins 24 for mating receipt with rim 10 to prevent slippage during rotation. However, pins 24 are not necessary for all applications and can even be dispensed with in applications where slippage is not an issue or pins 24 are otherwise not needed. Hub 22 is attached to a shaft 26 that connected by belt 28 to motor 30. Upon being powered by motor 30, hub 22 is caused to rotate within pedestal 20 and thereby rotate rim 10 when in position on hub 22. As will be understood by one of ordinary skill in the art, motor 30 is connected to a controller (not shown) so as to allow for the selective rotation of hub 22 and the determination of the speed of rotation as well.

Pedestal 20 is carried upon a slide 32 that can be selectively moved in the horizontal direction by sliding along a pair of cylindrical guide shafts 34. The position and movement of slide 32 is selectively determined by ball screw 36 powered by motor 38 (FIG. 3A), which is also connected to a controller. Slide 32 can be horizontally moved between a first position near support 40 and second position near support 42 (FIG. 3A). Movement of slide 32 will be further described herein.

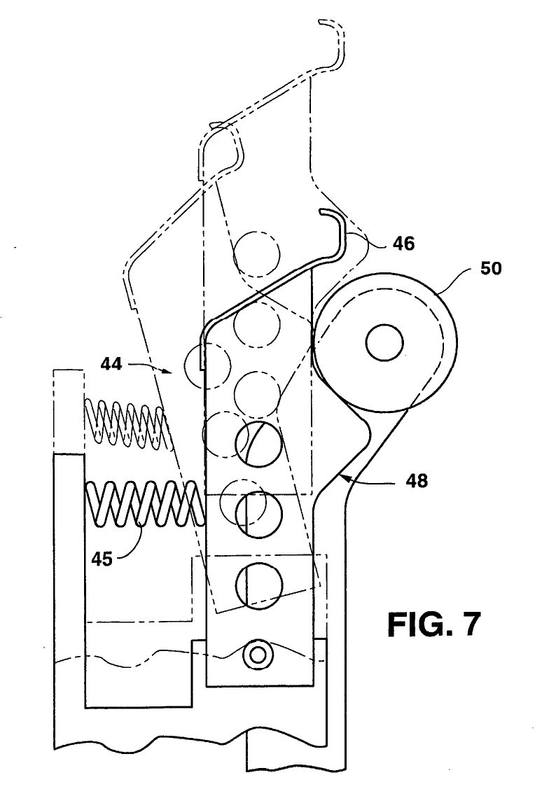

Actuator 44 is also carried by slide 32 and is located adjacent to pedestal 20. Actuator 44 includes a bead spoon 46 that is shaped to receive and hold the inside or bottom bead 16 of tire 12. Referring now to a close-up view of actuator 44 provided in FIG. 7, cam 48 is defined by actuator 44 and rides upon cam wheel 50 as actuator 44 is caused to move vertically. Spring 45 urges cam 48 against cam wheel 50. The vertical movement of actuator 44 and the resulting horizontal movement caused by cam 48 are illustrated by the phantom lines in FIG. 7. Accordingly, the precise distance between bead spoon 46 and hub 22 is varied by the action of cam 48 upon cam wheel 50 as actuator 44 moves vertically. Referring back to FIGS. 1 and 2, linear transducer 52, which is also connected to a controller, provides for the movement and precise vertical location of actuator 44 relative to slide 32. Guide 54 maintains the direction of this movement and guide stop 56 limits the vertical height to which actuator 44 may be raised.

Rim press 58 is also carried by slide 32. Press 58 includes a mandrel 60 that extends from cylinder 62. Wheel cone 64 is attached to mandrel 60 and is configured for complementary receipt by rim 10 as will be described below. Cone 64 freely rotates about mandrel 60. Cylinder 62, which is connected to a controller, can be used to selectively move mandrel 60 vertically and thereby secure rim 10 between cone 64 and hub 22 by forcing cone 64 downward. Pin 66 is received into a hole 68 defined by hub 22 to provide for alignment and to secure the position of rim 10.

Support ring positioner 70 (FIG. 2C) is attached overhead to frame 72. Positioner 70 includes a slide 74 that rides vertically along a pair of cylindrically shaped guides 76. Linear transducer 78, which is connected to a controller, provides for vertical movement and control of the precise vertical location of positioner 70. Outside bead element 80 is attached to slide 74 and includes a positioning wheel 82 that is located adjacent to hook-shaped tip 84. As will be described below, tip 84 is shaped for the receipt of outside or top bead 18 of tire 12 while positioning wheel 82 is configured for urging support ring 14 into its properly seated position along rim 10. Preferably, wheel 82 is provided with a beveled surface as shown for example in FIG. 2C so as provide for a margin of error in the placement of support ring 14 on rim 10 and to improve the ability to grab top bead 18 before positioning wheel 82 pushes down on support ring 14.

Continuing with FIGS. 1 and 2, upper and lower bead rollers 86 and 88 are also supported upon frame 72. Upper bead rollers 86 are carried by a pair of slides 90 that each ride upon a pair of cylindrically-shaped guides 92. The movement and position of upper bead rollers 86 is provided by a pair of cylinders 94 with a single cylinder 94 being attached to each slide 90 (only one cylinder 94 is visible in the figures). Similarly, lower bead rollers 88 are carried by a pair of slides 96 that each ride upon a pair of cylindrically-shaped guides 98. The movement and position of the lower bead rollers 88 is provided by a pair of cylinders 100 with a single cylinder 100 being attached to each slide 96 (only one cylinder 100 is visible in the figures).

As already described, slide 32 can be moved horizontally to a second position near support 42. Pedestal 20 is provided with a tapered shape so as to allow slide 32 to be carried into an opening between rollers 86 and 88. In this second position, slide 32 is positioned between a pair of exit conveyors 102 by which rim 10, tire 12, and support ring 14 can be lifted from hub 22 and conveyed away from pedestal 20 as will be later described.

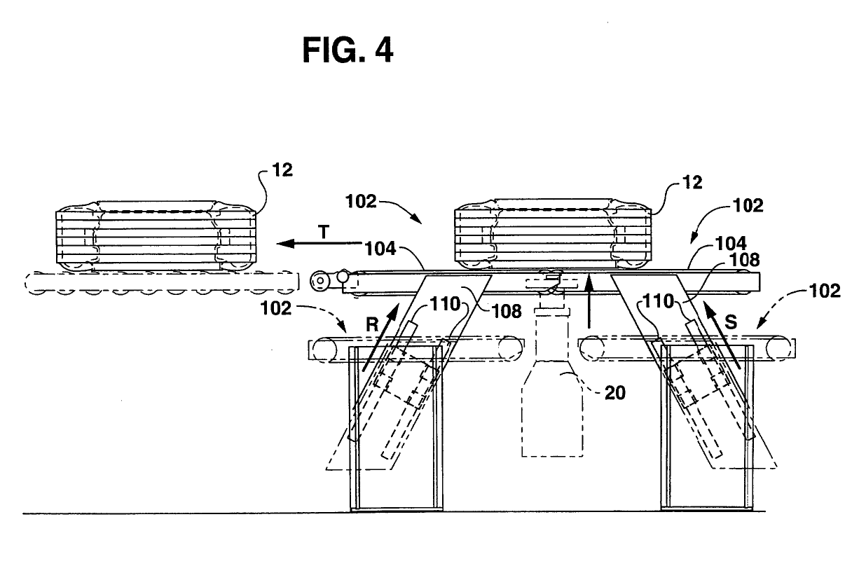

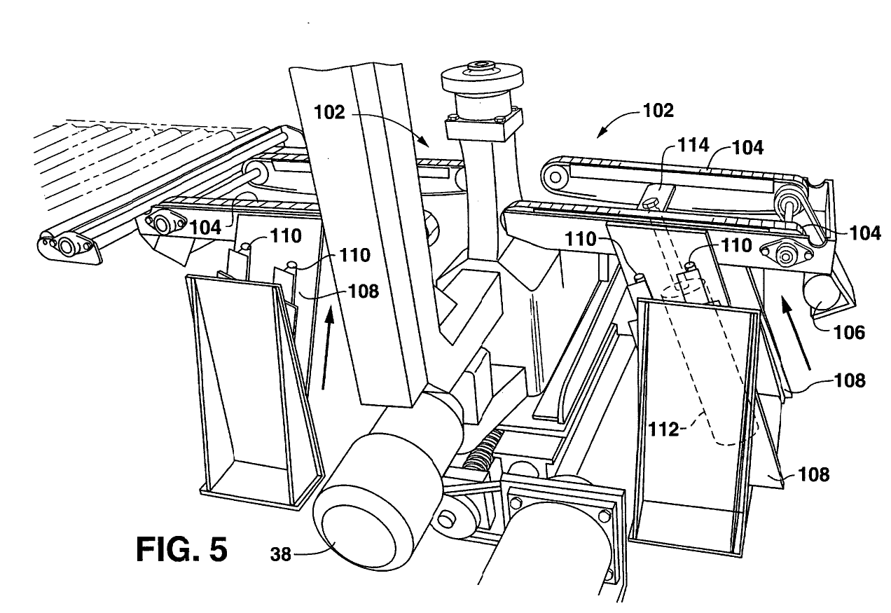

Referring now to FIG. 5, each exit conveyor 102 includes a pair of conveyor tracks 104 that can be operated by motor 106. Each conveyor track 104 is carried by a vertical slide 108. Each slide 108 is movable in the vertical direction by sliding along a pair of cylindrically-shaped guides 110. Power for this movement is provided by a pair of cylinders 112—one each connected to center plate 114 that in turn connects each pair of conveyor tracks 104. Vertical slides 108 and guides 110 are angled slightly so that as each pair of conveyor tracks 104 is hoisted by cylinders 112, tracks 104 overlap to provide a continuous path for the removal of a mounted tire 12 and support ring 14 from the pedestal 20. The overlap is illustrated in FIG. 4 for example.

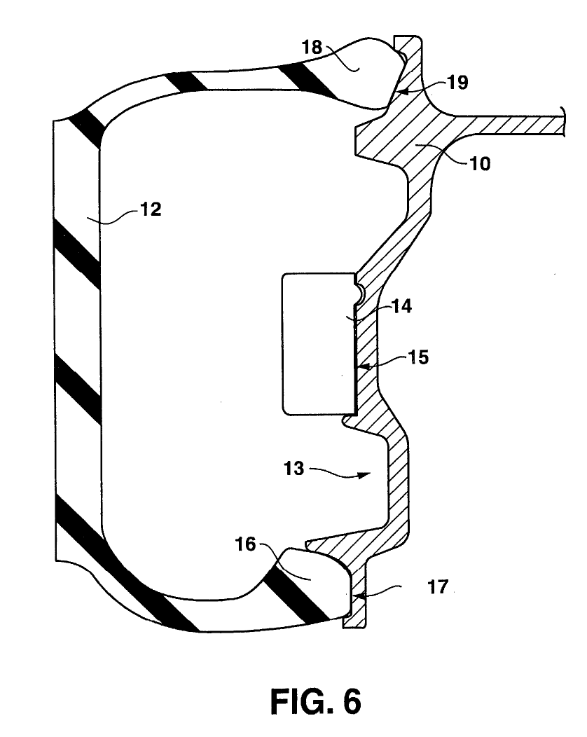

An exemplary method of using the above exemplary embodiment of the apparatus of the present invention for mounting tire 12 and support ring 14 onto rim 10 will now be described. Referring to FIG. 3A, with pedestal 20 located at an intermediate position between supports 40 and 42, rim 10 is placed onto hub 22. As shown in FIG. 3B, using linear transducer 52, actuator 44 is moved vertically upward so that bead spoon 46 is moved into inside rim well 13 (FIG. 6). For the purposes of illustration, FIG. 3B shows a gap between bead spoon 46 and rim 10. However, spoon 46 actually makes contact with, and rests within, inside rim well 13 of rim 10. With support ring 14 positioned within the cavity of tire 12, both ring 14 and tire 12 are placed onto rim 10. As shown in FIG. 3B, the lower or inside bead 16 is placed over and into bead spoon 46. Note the support ring 14 is placed onto rim 10 but still rests at a position vertically higher than rim 10 at this point.

Referring now to FIG. 3C, rim press 58 now lowers wheel cone 64 (illustrated by arrow A) towards pedestal 20 until rim 10 is secured firmly in-between. Slide 32 then carries pedestal 20 towards support 40 by the rotation of ball screw 36, which is illustrated by arrows B and C respectively. The amount of this movement of pedestal 20 is such that the hook-shaped tip 84 of outside bead element 80 can be lowered into the cavity of tire 12 in a position to catch the outside or top bead 18 of tire 12. Once pedestal 20 is moved the appropriate distance towards support 40, support ring positioner 70 moves outside bead element 80 vertically down towards rim 10 as illustrated by arrow D.

As shown in FIG. 3D, pedestal 20 is now moved in a direction away from support 40 as illustrated by arrow E. This movement causes hook-shaped tip 84 to catch outside bead 18 and pull tire 12 to one side so as to expose support ring 14. Referring to FIG. 3E, using hub 22 and motor 30, rim 10 and tire 12 are rotated (arrow F) as linear transducer 78 moves positioning wheel 82 onto support ring 14. As positioning wheel 82 moves downward (arrow G), support ring 14 is urged into its properly seated position on rim 10 (as shown in FIG. 6). Rollers 114 provide support to the rim during this operation (identified in FIG. 2A)

Looking now to FIG. 3F, once support ring 14 has been properly mounted on rim 10, positioning wheel 82 is moved away from support ring 14 (arrow H) as rotation of rim 10 ceases. Pedestal 20 is again moved towards support 40, as shown by arrow I in FIG. 3G, in order to release outside bead 18 from hook-shaped tip 84. Positioning wheel 82 and hook-shaped tip 84 are now removed from the cavity of tire 12 as shown by arrow J in FIG. 3H.

As illustrated by arrow I in FIG. 3I, pedestal 20 is now moved back towards an intermediate position between supports 40 and 42. Actuator 44 now causes bead spoon 46 to move radially outward from rim 10 and down so as to a position a portion of inside bead 16 to a position outside of rim 10 as illustrated by arrow U. As rim 10 is then rotated as shown by arrow K in FIG. 3J, all of inside bead 16 is pulled outside of rim 10. As shown, at this point, both inside bead 16 and outside bead 18 are outside of rim 10. Arrow L of FIG. 3K illustrates the downward movement of actuator 44, which cause lower bead spoon 46 to move radially inward from inside bead 16 and then down and out of tire 12.

Referring now to FIG. 3L, pedestal 20 is now moved towards support 42 (arrow M) until rim 10 is centered between upper bead rollers 86 and lower bead rollers 88. As shown in FIG. 3M, cylinders 94 and 100 moves towards each other (arrows N and O) urging the inside and outside beads 16 and 18 towards rim 10. As upper and lower bead rollers 86 and 88 each include two pairs of rollers (as shown in FIG. 1 for example), the initial contact between the rollers 86 and 88 and beads 16 and 18 occurs at two different places on each side of rim 10. More specifically, upper bead roller 86 will initially contact outside bead 18 at two different positions—such position being diametrically opposite from each other but both on outside bead 18. Similarly, lower bead rollers 88 will initially contact inside bead 16 at two different positions—such positions being diametrically opposite from each other but both on inside bead 16. While bead rollers 86 and 88 apply pressure to beads 16 and 18 as described, pedestal 20 is moved towards support 40 (arrow P in FIG. 3N and then towards support 42 (arrow Q in FIG. 3O). The pressure provided by bead rollers 86 and 88 during these movements of pedestal 20 operates to urge beads 16 and 18 into their respective seats 17 and 19 of rim 10 (as shown in FIG. 6).

Focusing now on FIG. 4, the completed assembly of tire 12 and supporting ring 14, each properly mounted onto rim 10, is ready for removal from hub 22 of pedestal 20. Accordingly, after raising wheel cone 64 from rim 10, vertical slides 108 are each raised towards one another by cylinders 112 as shown by arrows R and S. This action in turn lifts rim 10, tire 12, and support ring 14 away from hub 22. Conveyors tracks 104 are then rotated to move the rim 10, tire 12, and support ring 14 assembly away from the machine as illustrated by arrow T.

It should be understood that the present invention includes various other modifications that can be made to the exemplary embodiments of apparatus and method described herein that come within the scope of the appended claims and their equivalents. By way of example only, various changes to the method of operation including changes in the order of the steps may be made. Such differences in operation may be provided as alternatives in the programming options for the exemplary embodiment of the invention described above.

For example, in another exemplary method of operation, bead spoon 46 does not engage rim 10 until after support ring 14 is fully seated. More specifically, as previously described, pedestal 20 is initially located at an intermediate position between supports 40 and 42, and rim 10 is placed onto hub 22. Support ring 14 is placed onto rim 10 but still rests at a position vertically higher than rim 10 at this point. Rim press 58 now lowers wheel cone 64 towards pedestal 20 until rim 10 is secured firmly in-between. Slide 32 then carries pedestal 20 towards support 40 by the rotation of ball screw 36. The amount of this movement of pedestal 20 is such that the hook-shaped tip 84 of outside bead element 80 can be lowered into the cavity of tire 12 in a position to catch the outside or top bead 18 of tire 12. Once pedestal 20 is moved the appropriate distance towards support 40, support ring positioner 70 moves outside bead element 80 vertically down towards rim 10. Pedestal 20 is now moved a predetermined distance in a direction away from support 40 and towards support. This movement causes hook-shaped tip 84 to catch outside bead 18 and pull tire 12 to one side so as to expose support ring 14. Using hub 22 and motor 30, rim 10 and tire 12 are rotated (preferably three revolutions) as linear transducer 78 moves positioning wheel 82 onto support ring 14. As positioning wheel 82 moves downward, support ring 14 is urged into its properly seated position on rim 10.

Once support ring 14 has been properly mounted on rim 10, linear transducer 78 is moved upwards so as to cause hook-shaped tip 84 to pull tire 12 upwards by outside bead 18. This leaves a gap between rim 10 and inside bead 16. This gap is maintained while bead spoon 36 is raised upwardly into tire 12 and then seated against rim 10 in the same position as shown in FIG. 3B. Hook-shaped tip 84 then lowers outside bead 18 causing inside bead 16 to rest in bead spoon 36. Pedestal 20 is again moved towards support 40 in order to release outside bead 18 from hook-shaped tip 84. Pedestal 20 is now moved back towards an intermediate position between supports 40 and 42. Actuator 44 now causes bead spoon 46 to move radially outward from rim 10 and down so as to a position a portion of inside bead 16 to a position outside of rim 10. As rim 10 is then rotated, all of inside bead 16 is pulled outside of rim 10. As shown, at this point, both inside bead 16 and outside bead 18 are outside of rim 10.

Pedestal 20 is now moved towards support 40 until rim 10 is centered between upper bead rollers 86 and lower bead rollers 88. Upper bead rollers 86 are now urged towards rim 10 until full air pressure is obtained in cylinders 94. Then, as pedestal 20 is moved for a predetermined distance towards support 40, lower bead rollers 88 are urged into contact with rim 10 until full air pressure is obtained in cylinders 100. Pedestal 20 will now move a predetermined distance towards support 42 and beads 16 and 18 are urged into their respective seats 17 and 19 of rim 10 (as shown in FIG. 6). The completed assembly of tire 12 and support ring 14 are now removed from pedestal 20 as exited as previously described.

It should be understood that the present invention includes various other modifications that can be made to the exemplary embodiments of apparatus and method described herein that come within the scope of the appended claims and their equivalents. By way of examples only, the relative orientation of the machine may be changed—it being understood herein that references to vertical, horizontal, down, or up as used herein are relative only and can change with different orientations of the machine or its components. Also, the order of steps described with regard to the method described herein may be changed without departing from the spirit and scope of the present invention as set forth in the claims that follow. Additionally, it should be understood that the method described herein is not limited to any embodiment of the apparatus—it being understood by one of ordinary skill in the art that other embodiments of the apparatus may be used to perform these steps. Finally, and by way of further example only, in certain embodiments the present invention may be used solely for mounting a tire onto the rim rather than mounting both the tire and support ring. One of ordinary skill in the art, using the teaching described herein will understand how the operation of the exemplary apparatus described herein and its method of use may be modified to mount only a tire onto a rim. These and other embodiments of the method and apparatus of the present invention are with the spirit and scope of the claims that now follow.

1-20. (canceled)

21. A method of mounting a tire onto a wheel rim, the tire having an inside bead and an outside bead, the wheel rim defining axial and radial directions, the method comprising the steps of:
placing the tire over the rim such that the inside bead is located at an intermediate position around the rim and the outside bead is located axially outside of the rim;
rotating the rim;
moving the inside bead to a position axially outside of the rim during said step of rotating the rim; and
pressing the inside bead and the outside bead of the tire axially towards each other while moving the rim radially so as to urge the inside and outside bead into respective mounted positions on the rim.

22. A method of mounting a tire onto a wheel rim as in claim 21, further comprising the steps of:
inserting a support ring inside the tire prior to said placing step;
positioning the support ring onto the rim during said placing step such that the support ring is located at least partially around the rim; and
applying an axially directed force to the support ring while rotating the rim so as to urge the support ring into its mounted position.

23. A method of mounting a tire onto a wheel rim as in claim 22, further comprising a step of moving the outside bead generally in a radial direction so as to at least partially expose the support ring prior to said step of applying an axially directed force to the support ring.

24. A method of mounting a tire onto a wheel rim as in claim 21, wherein said pressing step comprises applying axially-directed forces initially at a position located substantially at the center of the wheel rim.

25. A method of mounting a tire onto a wheel rim as in claim 21, wherein said pressing step comprises simultaneously applying axially directed forces to the inside bead and the outside bead.

26. A method of mounting a tire onto a wheel rim as in claim 21, wherein the rim is moved sequentially in at least two opposing radial directions during said pressing step.

27. A method of mounting a tire onto a wheel rim as in claim 21, where the rim is rotated during said pressing step.

28. An apparatus for mounting a tire onto a wheel rim, the tire having an inside bead and an outside bead, the rim having an inside bead seat and an outside bead seat, the apparatus comprising:
a slide that is selectively movable between a first and second position;
a pedestal attached to said slide, said pedestal including a hub for the receipt of the rim, said hub defining axial and radial directions, said hub capable of being rotated about the axial direction;
an actuator attached to said slide, said actuator including an inside bead receiving element configured for receipt of the inside bead, said actuator configured with a cam that defines the radial position of said inside bead receiving element as said actuator is caused to move in the axial direction;
a rim press attached to said slide, said rim press including a shaft configured for rotation about the axial direction, said shaft being movable in the axial direction so as to selectively secure the rim between said shaft and said hub; and
a plurality of upper and lower bead rollers located proximate to the second position, said bead rollers being movable along the axial direction towards or away from the tire when in position on said hub, said bead rollers being configured for pressing the inside and outside bead rings into the inside and the bead seats respectively.

29. An apparatus for mounting a tire onto a wheel rim as in claim 28, further comprising: a support ring roller located proximate to the first position, said support ring roller including an outside bead receiving element configured for receipt of the outside bead of the tire, said support ring roller being movable along the axial direction towards or away from said slide.

30. An apparatus for mounting a tire onto a wheel rim as in claim 28, further comprising a first power source connected to said slide by a screw drive for selectively moving said slide between the first and the second positions.

31. An apparatus for mounting a tire onto a wheel rim as in claim 28, further comprising a second power source connected to said hub for selectively causing said hub to rotate about the axial direction.

32. An apparatus for mounting a tire onto a wheel rim as in claim 28, further comprising a third power source connected to said actuator for selectively causing said actuator to move in the axial direction.

33. An apparatus for mounting a tire onto a wheel rim as in claim 28, wherein said plurality of upper and lower bead rollers define an opening through which said pedestal may be carried by said slide towards the second position.

34. An apparatus for mounting a tire onto a wheel rim as in claim 28, further comprising a plurality of wheel support rollers located proximate to the first position and configured for supporting the tire as it is rotated by said hub.

35. An apparatus for mounting a tire onto a wheel rim as in claim 28, further comprising at least one exit conveyor, movable along the axial direction and located proximate to the second position, and configured for lifting the tire from said hub and transporting the tire away from said pedestal.

36. An apparatus for mounting a tire onto a wheel rim as claims 28, further comprising: at least one pair of exit conveyors;
a plurality of guides supporting said exit conveyors, said exit conveyors configured for sliding along said guides, said guides extending at an angle so that said exit conveyors overlap upon being moved towards one another along said guides; and
at least two cylinders attached to said exit conveyors and configured for selectively moving said exit conveyors along said guides.

37. An apparatus for mounting a tire onto a wheel rim as in claim 36, further comprising a linear transducer cylinder in mechanical communication with said support ring roller and so as to provide for selective movement of said support ring roller along the axial direction.

38. An apparatus for mounting a tire onto a wheel rim as in claim 28, further comprising a frame to which at least said slide, said rim press, and said plurality of upper and lower bead rollers are attached.

39. An apparatus for mounting a tire onto a wheel rim as in claim 28, wherein said shaft includes a wheel cone positioned at an end of the shaft and configured for complementary receipt by the wheel rim.

40. An apparatus for mounting a tire onto a wheel rim as in claim 28, wherein said cam is configured so as to cause said inside bead receiving element to pull the inside bead down and outside of the rim as said actuator is moved vertically downward.
